(19) United States
(12) Patent Application Publication
(10) Pub. No.: US 2007/0274262 A1
(43) Pub. Date: Nov. 29, 2007

(54) Home agent, registration method, network system and network roaming method

(75) Inventors: Wei-huai Hung, Tu-Cheng (TW); Jyh-cheng Chen, Tu-Cheng (TW); Ching-yuan Yu, Tu-Cheng (TW); Shao-hsiu Hung, Tu-Cheng (TW); Fu-cheng Chen, Tu-Cheng (TW); Meng-hui Ou, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: Hon Hai Precision Industry Co., LTD.

(21) Appl. No.: 11/647,886

(22) Filed: Dec. 29, 2006

(30) Foreign Application Priority Data
May 26, 2006 (TW) 95118788

(51) Int. Cl. H04Q 7/00

(52) U.S. Cl. 370/331

(57) ABSTRACT

A home agent (200) for registering with a serving node (400) in a home network (10) includes a packet filter module (210), an agent control module (220), and a registration module (240). The packet filter module detects a mobile registration packet transmitted from a mobile node (100) and informs the agent control module. The registration module registers with the serving node by transmitting a registration request packet when the agent control module is informed by the packet filter module. The registration request packet includes a home address field and a care-of address (CoA) field. The home address field is set to an Internet protocol (IP) address of the mobile node in the home network, and the CoA field is set to an IP address of the home agent. A registration method, a network system, and a network roaming method are also provided.

### BACKGROUND OF THE INVENTION

1. Field of the Invention

The invention relates to wireless communications, and particularly to a home agent, a registration method, a network system, and a network roaming method.

2. Description of Related Art

Recently the wireless local area network (WLAN) has been widely established and used, and the third generation mobile communication (3G) network starts to provide packet switching service. The WLAN has a faster data transfer rate, but a service scope thereof is limited. The 3G network can provide a wider service scope, but a data transfer rate thereof is much slower than that of the WLAN. As far as function is concerned, the WLAN and the 3G networks are complementary. Therefore, what is expected is a heterogeneous wireless network in which both the 3G network and the WLAN are co-existent and complementary.

However, when users make calls while moving in wireless networks, roaming between heterogeneous wireless networks may occur. At this point, due to different system architectures and different packet switching standards, communication interruption is prone to take place.

### SUMMARY OF THE INVENTION

An exemplary embodiment of the present invention provides a home agent that registers with a serving node in a home network. The home agent includes a packet filter module, an agent control module, and a registration module. The packet filter module detects a mobile registration packet transmitted from a mobile node and informs the agent control module. The registration module registers with the serving node by transmitting a registration request packet when the agent control module is informed by the packet filter module. The registration request packet includes a home address field and a care-of address (CoA) field. The home address field is set to an Internet protocol (IP) address of the mobile node in the home network, and the CoA field is set to an IP address of the home agent.

Another exemplary embodiment of the present invention provides a registration method used for a home agent registering with a serving node in a home network. The registration method includes receiving a mobile registration packet transmitted from a mobile node, and informing a registration module to register via an agent control module; and transmitting a registration request packet to the serving node for registration, wherein the registration request packet comprises a home address field and a CoA field, the home address field is set to an IP address of the mobile node in the home network, and the CoA field is set to an IP address of the home agent.

A further exemplary embodiment provides a network system. The network system includes a mobile node and a home agent. The mobile node roams from a home network to a foreign network, and includes a node control module for transmitting a mobile registration packet. The home agent registers with a serving node in the home network, and includes an agent control module, a packet filter module, and a registration module. The packet filter module detects the mobile registration packet transmitted from the mobile node, and informs the agent control module. The registration module registers with the serving node by transmitting a registration request packet when the agent control module is informed by the packet filter module. The registration request packet comprises a home address field and a CoA field. The home address field is set to an IP address of the mobile node in the home network, and the CoA field is set to an IP address of the home agent.

A still further exemplary embodiment provides a network roaming method used for a mobile node roaming from a home network to a foreign network. The method includes providing a home agent; transmitting a mobile registration packet from the mobile node to the home agent for registration; receiving the mobile registration packet by the home agent, and informing a registration module to register via an agent control module; and transmitting a registration request packet from the home agent to a serving node for registration, wherein the registration request packet comprises a home address field and a CoA field, the home address field is set to an IP address of the mobile node in the home network, and the CoA field is set to an IP address of the home agent.

Other advantages and novel features will become more apparent from the following detailed description when taken in conjunction with the accompanying drawings, in which:

### BRIEF DESCRIPTION OF THE DRAWINGS

FIG. 1 is schematic diagram of a network system of an exemplary embodiment of the present invention;

FIG. 2 is a schematic block diagram of functional modules of a mobile node and a home agent of another exemplary embodiment of the present invention;

FIG. 3 is a schematic diagram of a mobile Internet protocol (IP) registration (MIP_REG) packet of a further exemplary embodiment of the present invention;

FIG. 4 is a schematic diagram of a mobile IP reply (MIP_REP) packet of a further exemplary embodiment of the present invention;

FIG. 5 is a schematic diagram of a heterogeneous intersystem mobility registration request (HIM_REG_REQ) of a still further exemplary embodiment of the present invention;

FIG. 6 is a schematic diagram of a heterogeneous intersystem mobility registration reply (HIM_REG_REP) of a still further exemplary embodiment of the present invention;

FIG. 7 is a schematic diagram of a P-P registration request (P-P_REG_REQ) packet of a yet further exemplary embodiment of the present invention;

FIG. 8 is a schematic diagram of a P-P registration request (P-P_REG_REQ) packet of a yet further exemplary embodiment of the present invention;

FIG. 9 is a flowchart of a network roaming method of a still yet exemplary embodiment of the present invention;

FIG. 10 is a flowchart of a network roaming method of a still yet exemplary embodiment of the present invention; and

FIG. 11 is a flowchart of a network roaming method of a still yet exemplary embodiment of the present invention.

### DETAILED DESCRIPTION OF THE INVENTION

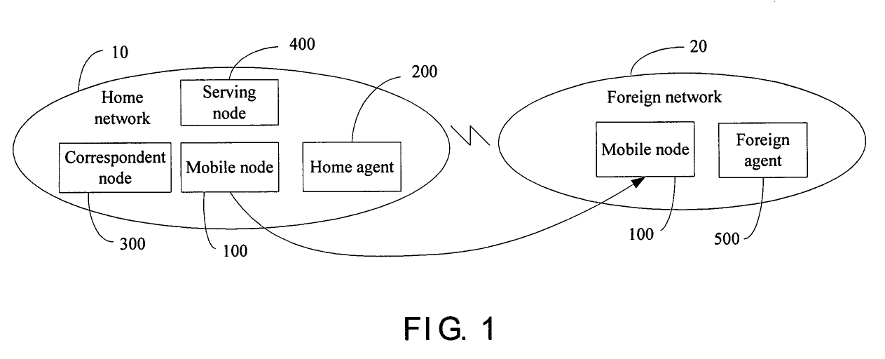

FIG. 1 is schematic diagram of a network system of an exemplary embodiment of the present invention. In the exemplary embodiment, the network system includes a home network 10 and a foreign network 20. The home network 10 may be a third generation partnership project (3GPP) network or a third generation partnership project 2 (3GPP2) network. The foreign network 20 may be a wireless local area network (WLAN).

The home network 10 includes a mobile node (MN) 100, a home agent (HA) 200, and a serving node 400. The home agent 200 and the serving node 400 provide services for the home network 10. The foreign network 20 includes a foreign agent (FA) 500. The foreign agent 500 provides services for the foreign network 20, and periodically transmits an advertisement packet.

The mobile node 100 can wirelessly communicate with a correspondent node (CN) 300. In the exemplary embodiment, the CN 300 may be located in the home network 10, the foreign network 20, or other networks.

The mobile node 100 can roam between the home network 10 and the foreign network 20. In the exemplary embodiment, the mobile node 100 registers with the home agent 200, and then the home agent 200 registers with the serving node 400. Thus, the mobile node 100 can maintain communication with the CN 300 when the mobile node 100 roams from the home network 10 to the foreign network 20.

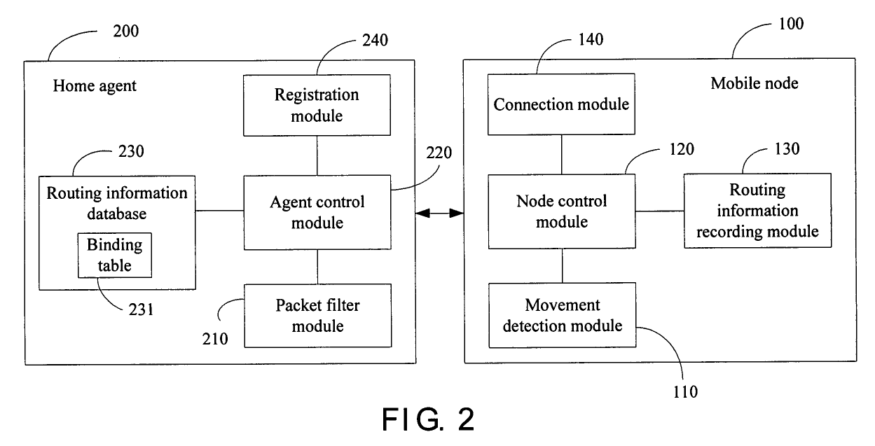

FIG. 2 is a schematic block diagram of functional modules of the mobile node 100 and the home agent 200 of an exemplary embodiment of the present invention. In the exemplary embodiment, the mobile node 100 includes a movement detection module 110, a node control module 120, a routing information recording module 130, and a connection module 140.

The movement detection module 110 detects whether the mobile node 100 is moving away from the home network 10 or roaming, and informs the node control module 120 when the mobile node 100 is roaming. In the exemplary embodiment, the foreign agent 500 periodically transmits the advertisement packet, and the advertisement packet includes a roaming identifier. The movement detection module 110 receives the advertisement packet from the foreign agent 500, and determines that the mobile node 100 roams from the home network 10 to the foreign network 20 according to the roaming identifier of the advertisement packet.

The node control module 120 controls the movement detection module 110, the routing information recording module 130, and the connection module 140. In the exemplary embodiment, when the movement detection module 110 detects the mobile node 100 is roaming, the node control module 120 informs the connection module 140 to acquire a care-of address (CoA) from the foreign network 20.

The connection module 140 acquires the CoA from the foreign network 20. In the exemplary embodiment, the foreign network 20 is a WLAN, and the connection module 140 listens to the advertisement packet transmitted by the foreign agent 500 to acquire the CoA, namely a foreign agent (FA) CoA.

In other embodiments, the foreign network 20 may further include a dynamic host configuration protocol (DHCP) server, and the connection module 140 may acquire the CoA from the DHCP server, namely a co-located CoA (CCoA).

After the connection module 140 acquires the CoA, the node control module 120 transmits a mobile registration packet to the home agent 200 for registration. The mobile registration packet includes a home address field and a CoA address field. The home address field is set to an Internet protocol (IP) address of the mobile node 100 in the home network 10, and the CoA address field is set to the CoA acquired by the connection module 140. In the exemplary embodiment, the mobile registration packet is a mobile IP registration (MIP_REG) packet 1000.

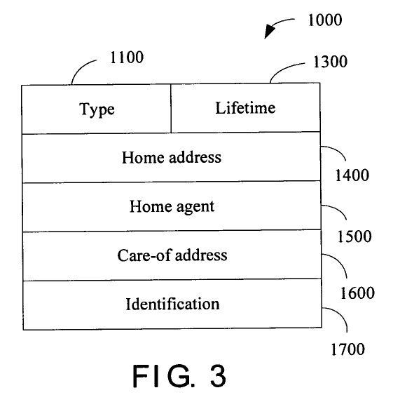

Referring to FIG. 3, the MIP_REG packet 1000 includes a type field 1100, a lifetime field 1300, a home address field 1400, a home agent field 1500, a CoA address field 1600, and an identification field 1700. It should be noted that each frame in the exemplary embodiment conforms to known mobile IP standards, and only relevant fields instead of all fields of the frame are disclosed. The type field 1100 indicates a type of the MIP_REG packet 1000, namely distinguishing the MIP_REG packet 1000 from a mobile Internet protocol reply (MIP_REP) packet. In the exemplary embodiment, the type field 1100 is set to 1, indicating the packet is an MIP_REG packet.

The lifetime field 1300 indicates a lifetime of the MIP_REG packet 1000. That is, the MIP_REG packet 1000 is regarded to be overdue and invalid after the lift time indicated by the lifetime field 1300. The home address field 1400 is set to the IP address of the mobile node 100 in the home network 10. The home agent field 1500 is set to an IP address of the home agent 200. The CoA field 1600 is set to the CoA of the mobile node 100, namely the CoA acquired by the connection module 140. The identification field 1700 indicates an identification of the MIP_REG packet 1000.

After receiving the mobile registration packet transmitted from the mobile node 100, the home agent 200 registers with the serving node 400. When the home agent 200 successfully registers with the serving node 400, the home agent 200 transmits a mobile reply packet to the node control module 120 of the mobile node 100. In the exemplary embodiment, the mobile reply packet is a MIP_REP packet 2000.

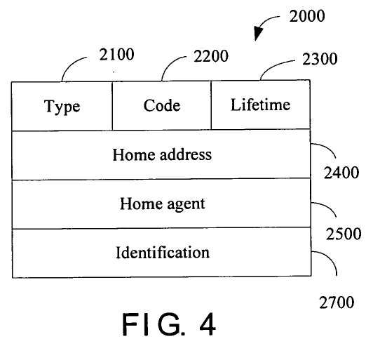

As shown in FIG. 4, the MIP_REP packet 2000 includes a type field 2100, a code field 2200, a lifetime field 2300, a home address field 2400, a home agent field 2500, and an identification field 2700. The type field 2100 indicates a type of the MIP_REP packet 2000. In the exemplary embodiment, when the type field 2100 is set to 3, the packet is referred to as an MIP_REP packet. The code field 2200 informs the mobile node 100 whether the MIP_REG packet 1000 is successfully registered. In the exemplary embodiment, when the code field 2200 is set to 0, it indicates that the MIP_REG packet 1000 is successfully registered.

The lifetime field 2300 indicates a lifetime of the MIP_REP packet 2000. The home address field 2400 is set to the IP address of the mobile node 100 in the home network 10. The home agent field 2500 is set to the IP address of the home agent 200. The identification field 2700 indicates an identification of the MIP_REP packet 2000.

The routing information recording module 130 manages routing packet information of the mobile node 100. In the exemplary embodiment, when the node control module 120 successfully registers with the home agent 200, the node control module 120 informs the routing information recording module 130 amends the routing packet information of the mobile node 100 according to the CoA acquired by the connection module 140.

The home agent 200 receives the mobile registration packet, and registers with the serving node 400 by transmitting a registration request packet. In the exemplary embodiment, the home agent 200 includes a packet filter module 210, an agent control module 220, a routing information database 230, and a registration module 240.

The packet filter module 210 detects the mobile registration packet transmitted from the mobile node 100, and informs the agent control module 220. In the exemplary embodiment, the packet filter module 210 detects the mobile registration packet transmitted from the mobile node 100, and then transmits the mobile registration packet to the agent control module 220.

In other embodiments, when receiving general packets, namely non-mobile registration packets, the packet filter module 210 discards the general packets.

The agent control module 220 manages the packet filter module 210, the routing information database 230, and the registration module 240. In the exemplary embodiment, after receiving the mobile registration packet from the packet filter module 210, the agent control module 220 informs the routing information database 230 to amend the routing packet information of the mobile node 100 according to the mobile registration packet.

The routing information database 230 manages the routing packet information of the mobile node 100. In the embodiment, the routing information database 230 includes a binding table 231. The binding table 231 includes mapped relationships between the IP address of the mobile node 100 in the home network 10 and the CoA address of the mobile node 100. Whenever the mobile node 100 enters a new foreign network and transmits a new mobile registration packet to the home agent 200, the routing information database 230 will update the binding table 231 according to the new mobile registration packet. In the exemplary embodiment, when the mobile node 100 enters the foreign network 20, and transmits the MIP_REG packet 1000 to the home agent 200, the routing information database 230 updates the binding table 231 according to the MIP_REG packet 1000.

The registration module 240 registers with the serving node 400 when the agent control module 220 is informed by the packet filter module 210. In the exemplary embodiment, when the agent control module 220 receives the mobile registration packet from the packet filter module 210, the agent control module 220 informs the registration module 240 to register with the serving node 400. The registration module 240 transmits a registration request packet to the serving node 400 for registration, in order to inform the serving node 400 about a roaming state of the mobile node 100 and ask the serving node 400 to transmit packets meant for the mobile node 100 to the home agent 200. In the exemplary embodiment, the registration request packet includes a home address field and a CoA field. The home address field is set to the IP address of the mobile node 100 in the home network 10, and the CoA field is set to the IP address of the home agent 200.

After receiving the registration request packet, the serving node 400 transmits a registration reply packet to the registration module 240 for informing of successful registration. Therefore, if the registration module 240 receives the registration reply packet from the serving node 400, the home agent 200 has successfully registered with the serving node 400.

In the exemplary embodiment, the home network 10 is a 3GPP network, and the serving node 400 is a gateway general packet radio service (GPRS) support node (GGSN). The registration request packet is a heterogeneous intersystem mobility registration request (HIM_REG_REQ) packet 3000, and the registration reply packet is a heterogeneous intersystem mobility registration reply (HIM_REG_REP) packet 4000.

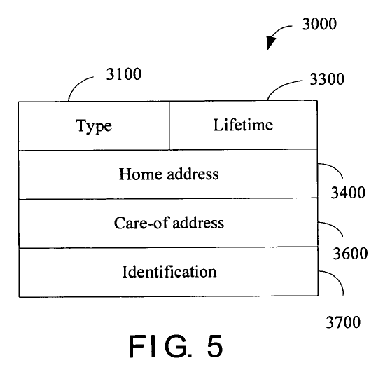

Referring to FIG. 5, the HIM_REG_REQ packet 3000 includes a type field 3100, a lifetime field 3300, a home address field 3400, a CoA address field 3600, and an identification field 3700. The type field 3100 indicates a type of the HIM_REG_REQ packet 3000, namely distinguishing the HIM_REG_REQ packet 3000 from an HIM_REG_REP packet. In the exemplary embodiment, the type field 3100 is set to 1, indicating the packet is an HIM_REG_REQ packet.

The lifetime field 3300 indicates a lifetime of the HIM_REG_REQ packet 3000. The home address field 3400 is set to the IP address of the mobile node 100 in the home network 10. The CoA field 3600 is set to the IP address of the home agent 200. The identification field 3700 indicates an identification of the HIM_REG_REQ packet 3000.

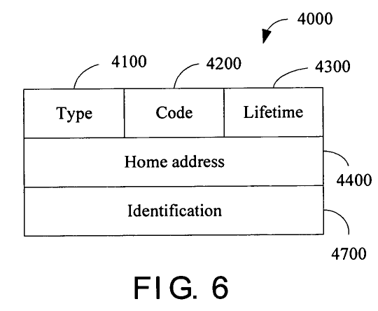

As shown in FIG. 6, the HIM_REG_REP packet 4000 includes a type field 4100, a code field 4200, a lifetime field 4300, a home address field 4400, and an identification field 4700. The type field 4100 indicates a type of the HIM_REG_REP packet 4000. In the exemplary embodiment, when the type field 4100 is set to 3, the packet is referred to as an HIM_REG_REP packet. The code field 4200 informs the home agent 200 whether the HIM_REG_REP packet 3000 is successfully registered. In the exemplary embodiment, when the code field 4200 is set to 0, it indicates that the HIM_REG_REP packet 3000 is successfully registered.

The lifetime field 4300 indicates a lifetime of the HIM_REG_REP packet 4000. The home address field 4400 is set to the IP address of the mobile node 100 in the home network 10. The identification field 4700 indicates an identification of the HIM_REG_REP packet 4000.

In another embodiment, the home network 10 may be a 3GPP2 network, and the serving node 400 may be a packet data serving node (PDSN). The registration request packet may be a P-P registration request (P-P_REG_REQ) packet 5000, and the registration reply packet may be a P-P registration reply (P-P_REG_REP) packet 6000.

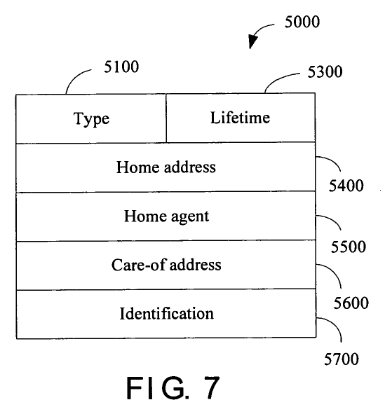

Referring to FIG. 7, the P-P_REG_REQ packet 5000 includes a type field 5100, a lifetime field 5300, a home address field 5400, a home agent field 5500, a CoA address field 5600, and an identification field 5700. The type field 5100 indicates a type of the P-P_REG_REQ packet 5000, namely distinguishing the P-P_REG_REQ packet 5000 from a P-P_REG_REP packet. In the exemplary embodiment, the type field 5100 is set to 1, indicating the packet is a P-P_REG_REQ packet.

The lifetime field 5300 indicates a lifetime of the P-P_REG_REQ packet 5000. The home address field 5400 is set to the IP address of the mobile node 100 in the home network 10. The home agent field 5500 is set to an IP address of the serving node 400. The CoA field 5600 is set to the IP address of the home agent 200. The identification field 5700 indicates an identification of the P-P_REG_REQ packet 5000.

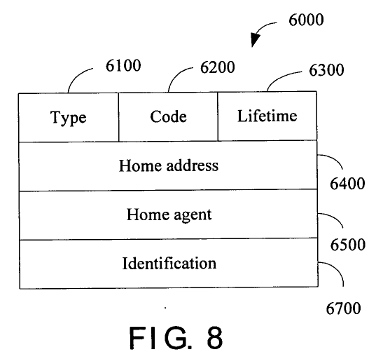

As shown in FIG. 8, the P-P_REG_REP packet 6000 includes a type field 6100, a code field 6200, a lifetime field 6300, a home address field 6400, a home agent field 6500, and an identification field 6700. The type field 6100 indicates a type of the P-P_REG_REP packet 6000. In the exemplary embodiment, when the type field 6100 is set to 3, it indicates the packet is a P-P_REG_REP packet. The code field 6200 informs the home agent 200 whether the P-P_REG_REQ packet 5000 is successfully registered. In the exemplary embodiment, when the code field 6200 is set to 0, it indicates that the P-P_REG_REP packet 5000 is successfully registered.

The lifetime field 6300 indicates a lifetime of the P-P_REG_REP packet 6000. The home address field 6400 is set to the IP address of the mobile node 100 in the home network 10. The home agent field 6500 is set to the IP address of the serving node 400. The identification field 6700 indicates an identification of the P-P_REG_REP packet 6000.

When the home agent 200 successfully registers with the serving node 400, the agent control module 220 of the home agent 200 further transmits the mobile reply packet to the mobile node 100 for informing of successful registration.

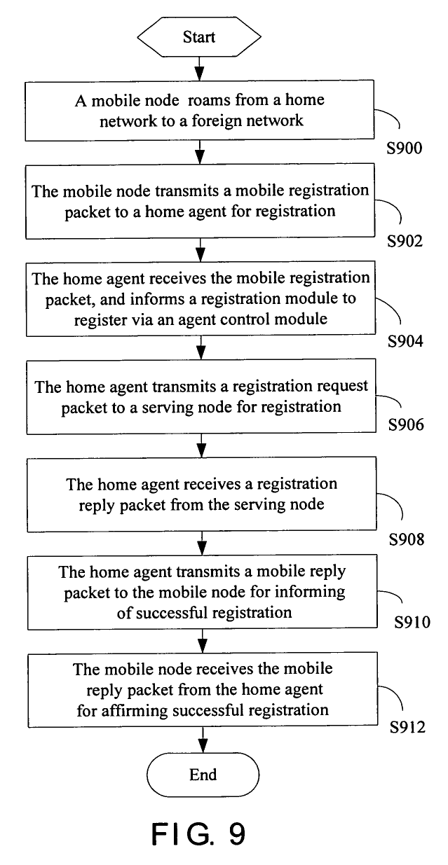

FIG. 9 is a flowchart of a network roaming method of an exemplary embodiment of the present invention. In the exemplary embodiment, the mobile node 100 roams from the home network 10 to the foreign network 20 while maintaining communication.

In step S900, the mobile node 100 roams from the home network 10 to the foreign network 20.

In step S902, the mobile node 100 transmits a mobile registration packet to the home agent 20 for registration.

In step S904, the home agent 200 receives the mobile registration packet, and informs the registration module 240 to register via the agent control module 220.

In step S906, the home agent 200 transmits a registration request packet to the serving node 400 for registration. In the embodiment, the registration request packet includes a home address field and a CoA field. The home address field is set to the IP address of the mobile node 100 in the home network 10, and the CoA field is set to the IP address of the home agent 200.

In step S908, the home agent 200 receives a registration reply packet from the serving node 400 for affirming successful registration.

In step S910, the home agent 200 transmits a mobile reply packet to the mobile node 100 for informing of successful registration.

In step S912, the mobile node 100 receives the mobile reply packet from the home agent 200 for affirming successful registration.

In the network roaming method of FIG. 9, the steps S904, S906, and S908 constitute a method for the home agent 200 registering with the serving node 400, namely a flow of a registration method of an exemplary embodiment of the present invention.

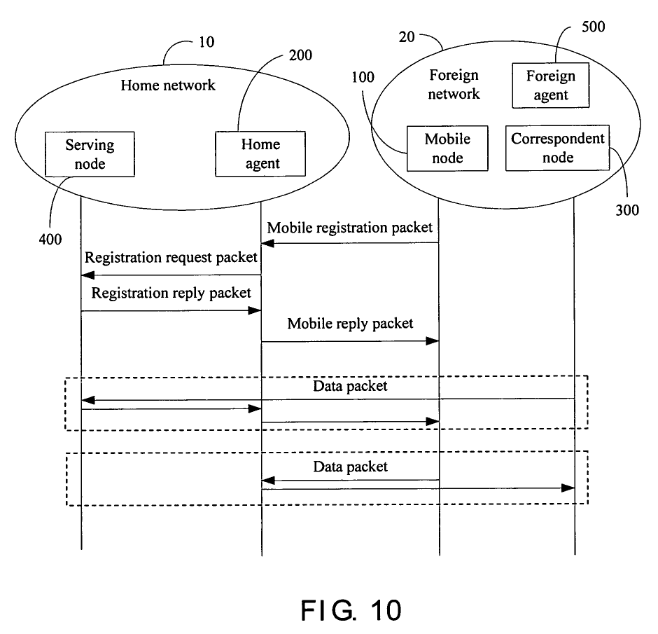

FIG. 10 is a flowchart of a network roaming method of another exemplary embodiment of the present invention. The difference between this embodiment and the above embodiment of FIG. 9 is that the CN 300 is in the foreign network 20. When the mobile node 100 roams from the home network 10 to the foreign network 20, the mobile node 100 needs to maintain communication with the CN 300.

First, the mobile node 100 detects the mobile node 100 roams. In the embodiment, the foreign agent 500 periodically transmits an advertisement packet, and the advertisement packet includes a roaming identifier. The mobile node 100 receives the advertisement packet from the foreign agent 500, and determines whether the mobile node 100 is roaming according to the roaming identifier of the advertisement packet, namely detecting the mobile node 100 roams from the home network 10 to the foreign network 20.

Then, the mobile node 100 acquires a CoA from the foreign network 20. In the exemplary embodiment, the foreign network 20 is a WLAN, the mobile node 100 listens to the advertisement packet from the foreign agent 500 to acquire the foreign agent's CoA, namely an FA CoA.

In other embodiments, the foreign network 20 may further include a DHCP server, and the mobile node 100 may acquire the CoA from the DHCP server, namely a CCoA.

After acquiring the CoA, the mobile node 100 registers with the home agent 200. The mobile node 100 transmits a mobile registration packet to the home agent 200 for registration. The mobile registration packet includes a home address field and a CoA address field. The home address field is set to the IP address of the mobile node 100 in the home network 10, and the CoA address field is set to the CoA acquired by the mobile station 100. In the exemplary embodiment, the mobile registration packet is an MIP_REG packet 1000. Referring to FIG. 3, the MIP_REG packet 1000 includes the type field 1100, the lifetime field 1300, the home address field 1400, the home agent field 1500, the CoA address field 1600, and the identification field 1700. The MIP_REG packet 1000 is described above, so descriptions are omitted here.

After receiving the mobile registration packet transmitted from the mobile node 100, the home agent 200 amends the routing packet information of the mobile node 100 by updating the binding table 231 according to the mobile registration packet.

Then, the home agent 200 registers with the serving node 400. In the exemplary embodiment, the home agent 200 transmits a registration request packet to the serving node 400 for registration, in order to inform the serving node 400 about a roaming state of the mobile node 100 and ask the serving node 400 to transmit packets meant for the mobile node 100 to the home agent 200. The registration request packet includes a home address field and a CoA field. The home address field is set to the IP address of the mobile node 100 in the home network 10, and the CoA field is set to the IP address of the home agent 200.

After receiving the registration request packet, the serving node 400 transmits a registration reply packet to the home agent 200. Therefore, the home agent 200 successfully registers with the serving node 400.

In the exemplary embodiment, the home network 10 is a 3GPP network, and the serving node 400 is a GGSN. The registration request packet is the HIM_REG_REQ packet 3000, and the registration reply packet is the HIM_REG_REP packet 4000. Referring to FIG. 5 again, the HIM_REG_REQ packet 3000 includes the type field 3100, the lifetime field 3300, the home address field 3400, the CoA address field 3600, and the identification field 3700. In the exemplary embodiment, the type field 3100 is set to 1, indicating the packet is an HIM_REG_REQ packet. The lifetime field 3300 indicates a lifetime of the HIM_REG_REQ packet 3000. The home address field 3400 is set to the IP address of the mobile node 100 in the home network 10. The CoA field 3600 is set to the IP address of the home agent 200. The identification field 3700 indicates an identification of the HIM_REG_REQ packet 3000.

In another embodiment, the home network 10 may be a 3GPP2 network, and the serving node 400 may be a PDSN. The registration request packet may be a P-P_REG_REQ packet 5000, and the registration reply packet may be a P-P_REG_REP packet 6000. Referring to FIG. 7 again, the P-P_REG_REQ packet 5000 includes the type field 5100, the lifetime field 5300, the home address field 5400, the home agent field 5500, the CoA address field 5600, and the identification field 5700. In the exemplary embodiment, the type field 5100 is set to 1, indicating the packet is a P-P_REG_REQ packet. The lifetime field 5300 indicates a lifetime of the P-P_REG_REQ packet 5000. The home address field 5400 is set to the IP address of the mobile node 100 in the home network 10. The home agent field 5500 is set to the IP address of the serving node 400. The CoA field 5600 is set to the IP address of the home agent 200. The identification field 5700 indicates an identification of the P-P_REG_REQ packet 5000.

After successfully registering with the serving node 400, the home agent 200 further transmits a mobile reply packet to the mobile node 100 for informing of successful registration.

Then, the mobile node 100 receives the mobile reply packet from the home agent for affirming the successful registration. In the exemplary embodiment, when successfully registering with the home agent 100, the mobile node 100 amends the routing packet information thereof according to the CoA acquired by the mobile node 100.

In the exemplary embodiment, after the mobile node 100 successfully registers with the home agent 200, if the CN 300 needs to transmit a data packet to the mobile node 100, the data packet must first be transmitted to the serving node 400. Then the serving node 400 transmits the data packet to the home agent 200. Finally, the home agent 200 transmits the data packet to the mobile node 100. If the mobile node 100 needs to transmit a data packet to the CN 300, the data packet must first be transmitted to the home agent 200. Then the home agent 200 transmits the data packet to the CN 300.

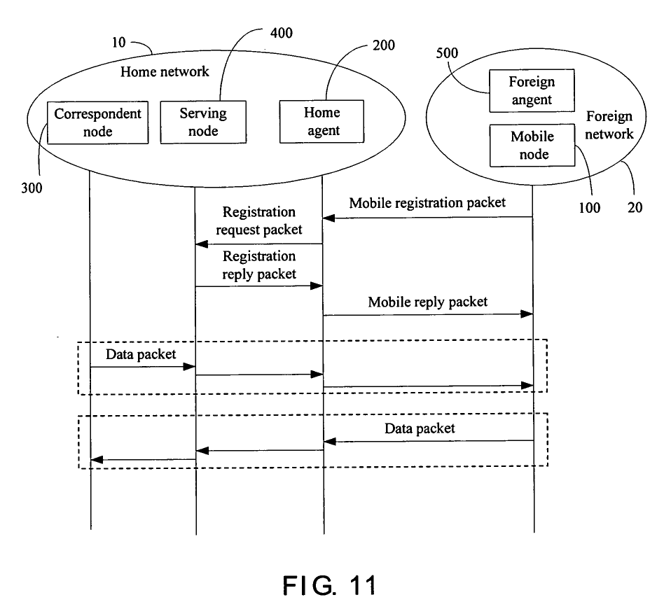

In another embodiment, referring to FIG. 11, the CN 300 is in the home network 10. In this embodiment, after the mobile node 100 successfully registers with the home agent 200, if the CN 300 needs to transmit a data packet to the mobile node 100, the data packet must first be transmitted to the serving node 400. Then the serving node 400 transmits the data packet to the home agent 200. Finally, the home agent 200 transmits the data packet to the mobile node 100. If the mobile node 100 needs to transmit a data packet to the CN 300, the data packet must first be transmitted to the home agent 200. Then the home agent 200 transmits the data packet to the serving node 400. Finally, the serving node 400 transmits the data packet to the CN 300.

Thus, when the mobile node 100 roams from the home network 10 to the foreign network 20, communication with the CN 300 can be maintained.

While exemplary embodiments have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A home agent, for registering with a serving node in a home network, comprising:
an agent control module;
a packet filter module, for detecting a mobile registration packet transmitted from a mobile node, and informing the agent control module; and
a registration module, for registering with the serving node by transmitting a registration request packet when the agent control module is informed by the packet filter module, wherein the registration request packet comprises a home address field and a care-of address (CoA) field, the home address field is set to an Internet protocol (IP) address of the mobile node in the home network, and the CoA field is set to an IP address of the home agent.

2. The home agent as claimed in claim 1, further comprising a routing information database, for managing routing packet information of the mobile node.

3. The home agent as claimed in claim 2, wherein the routing information database comprises a binding table, the binding table comprises mapped relationships between the IP address of the mobile node in the home network and a CoA of the mobile node, and the routing information database is further for receiving the mobile registration packet via the agent control module, and updating the binding table according to the mobile registration packet.

4. The home agent as claimed in claim 1, wherein the registration request packet further comprises a type field, a lifetime field, and an identification field; the type field indicates a type of the registration request packet, the lifetime field indicates a lifetime of the registration request packet, and the identification field indicates an identification of the registration request packet.

5. The home agent as claimed in claim 1, wherein the registration request packet further comprises a type field, a lifetime field, a home agent field, and an identification field; the type field indicates a type of the registration request packet, the lifetime field indicates a lifetime of the registration request packet, the home agent field is set to an IP address of the serving node, and the identification field indicates an identification of the registration request packet.

6. A network system, comprising:
a mobile node, roaming from a home network to a foreign network, the mobile node comprising a node control module, for transmitting a mobile registration packet; and
a home agent, for registering with a serving node in the home network, comprising:
an agent control module;
a packet filter module, for detecting the mobile registration packet transmitted from the mobile node, and informing the agent control module; and
a registration module, for registering with the serving node by transmitting a registration request packet when the agent control module is informed by the packet filter module, wherein the registration request packet comprises a home address field and a care-of address (CoA) field, the home address field is set to an Internet protocol (IP) address of the mobile node in the home network, and the CoA field is set to an IP address of the home agent.

7. The network system as claimed in claim 6, wherein the mobile node further comprises a movement detection module for detecting whether the mobile node is roaming and informing the node control module when the mobile node is roaming, and a connection module for acquiring a CoA from the foreign network.

8. The network system as claimed in claim 7, further comprising a foreign agent for transmitting an advertisement packet, wherein the movement detection module is for determining that the mobile node roams from the home network to the foreign network according to a roaming identifier of the advertisement packet, and the connection module is for listening to the advertisement packet to acquire the CoA.

9. The network system as claimed in claim 7, wherein the mobile registration packet comprises a home address field and a CoA field, the home address field is set to the IP address of the mobile node in the home network, and the CoA field is set to the CoA acquired by the connection module.

10. The network system as claimed in claim 9, wherein the mobile registration packet is a mobile IP (MIP) registration packet, the mobile IP registration packet further comprises a type field, a lifetime field, a home agent field, and an identification field, and the home agent field is set to the IP address of the home agent.

11. The network system as claimed in claim 7, wherein the mobile node further comprises a routing information recording module, for receiving the CoA acquired by the connection module via the node control module, and amending the routing packet information of the mobile node according to the CoA.

12. A method used for a mobile node roaming from a home network to a foreign network, comprising:
transmitting a mobile registration packet from a mobile node to a home agent actively functioning in a home network where the mobile node roams therefrom for registration;
receiving the mobile registration packet by the home agent in the home network to register the mobile node in a foreign network where the mobile node roams thereto; and
transmitting a registration request packet from the home agent to a serving node in the home network for registration so that the mobile node is able to continue communication with a correspondent node in one of the home network and the foreign network via help of the serving node and the home agent.

13. The method as claimed in claim 12, wherein the transmitted registration request packet from the home agent to the serving node comprises a home address field and a care-of address (CoA) field, the home address field is set to an Internet protocol (IP) address of the mobile node in the home network, and the CoA field is set to an IP address of the home agent.

14. The method as claimed in claim 12, further comprising:
acquiring a care-of address (CoA) from the foreign network by the mobile node; and
amending routing packet information of the mobile node according to the CoA so as to include the routing packet information in the mobile registration packet.

15. The method as claimed in claim 14, wherein the step of acquiring the CoA comprises:
providing a foreign agent in the foreign network for transmitting an advertisement packet; and
listening to the advertisement packet to acquire the CoA.

16. The method as claimed in claim 14, further comprising:
providing a binding table in the home agent comprising mapped relationships between the IP address of the mobile node in the home network and the CoA of the mobile node in the foreign network; and
updating the binding table according to the mobile registration packet.

17. The method as claimed in claim 12, further comprising:
receiving a registration reply packet from the serving node by the home agent; and
transmitting a mobile reply packet from the home agent to mobile node for informing of successful registration.
